(19) United States
(12) Patent Application Publication
(10) Pub. No.: US 2025/0122382 A1
(43) Pub. Date: Apr. 17, 2025

(54) GEOPOLYMER COATINGS

(71) Applicant: Louisiana Tech Research Corporation; of Louisiana Tech University Foundation, Inc., Ruston, LA (US)

(72) Inventor: Joan G. Lynam, Ruston, LA (US)

(21) Appl. No.: 18/912,729

(22) Filed: Oct. 11, 2024

Related U.S. Application Data
(60) Provisional application No. 63/590,146, filed on Oct. 13, 2023.

(51) Int. Cl. C09D 1/04

(52) U.S. Cl. CPC C09D 1/04

(57) ABSTRACT

A geopolymer coating provides heat resistance to an exposure of a temperature in the range of about 1600° C. to 2000° C. The geopolymer coating includes solids, a first alkali, a second alkali, and water. The solids include fly ash and shrimp shell powder.

### CROSS-REFERENCE TO RELATED APPLICATIONS

This application claims the benefit of, and priority to, U.S. Provisional Patent Application Ser. No. 63/590,146 filed on Oct. 13, 2023. The entire contents of the foregoing application is incorporated by reference herein.

### TECHNICAL FIELD

The present disclosure generally relates to cement-free advanced geopolymer coatings and methods for making them. The geopolymer coatings may utilize techno-economically feasible indigenous and local natural resource materials. The geopolymer coatings exhibit various characteristics, including flame resistance, water resistance, and high temperature resistance.

### BACKGROUND

Unless otherwise indicated herein, the materials described in this section are not prior art to the claims herein and are not admitted as being prior art by inclusion in this section.

Conventional geopolymeric systems may utilize fly ashes and slags as primary raw material sources of silica, alumina, and calcium along with solutions of alkaline activator for making geopolymer paste, mortar, and concrete. Fly ashes may be generated in thermal power plants due to the burning of coal and may be a substantial source of liberated carbon dioxide, a greenhouse gas considered to contribute to the serious concern about climate change leading to hurricanes, global warming, etc. The transportation of fly ashes from distant thermal power plants may become cost-prohibitive and the flying nature of fly ashes may require special care in handling and transporting.

### SUMMARY

Existing challenges associated with the foregoing, as well as other challenges, are overcome by the presently disclosed geopolymer coatings. One embodiment of the present disclosure is a geopolymer coating which provides heat resistance which is produced with solids including ground shrimp shells. The geopolymer coating includes solids, a first alkali, a second alkali, and water. The solids include fly ash and shrimp shell powder. The geopolymer coating formulation provides heat resistance to an exposure of a temperature in the range of about 1600° C. to 2000° C.

In aspects, the solids may include up to 30% shrimp shell powder.

In aspects, the first alkali may be sodium hydroxide (NaOH).

In aspects, the second alkali may be sodium silicate (Na₂SiO₃).

In aspects, the geopolymer coating may have a ratio of first alkali to second alkali of 1:1.25.

In aspects, the shrimp shell powder may include ground powder of shrimp shells with a particle size of about 850 μm.

In aspects, the water may be de-ionized water.

In aspects, the geopolymer coating may include about 34 weight % fly ash, about 2 weight % shrimp shell powder, about 4 weight % sodium hydroxide, about 5 weight % sodium silicate, and about 56 weight % water.

In aspects, the geopolymer coating may include about 32 weight % fly ash, about 3.5 weight % shrimp shell powder, about 4 weight % sodium hydroxide, about 5 weight % sodium silicate, and about 56 weight % water.

In aspects, the geopolymer coating may include about 28 weight % fly ash, about 7 weight % shrimp shell powder, about 4 weight % sodium hydroxide, about 5 weight % sodium silicate, and about 56 weight % water.

Another embodiment of the present disclosure includes a method of making the geopolymer coatings. The method includes placing solids into a chamber and mixing the solids in the chamber to form a powder. The method further includes pouring a first alkali into the chamber and includes mixing the first alkali with the powder in the chamber to form a first mixture. The method further includes pouring a second alkali into the chamber and mixing the second alkali with the first mixture in the chamber to form a second mixture. The method further includes adding water to the chamber and mixing the water with the second mixture to form the geopolymer coating.

In aspects, the method may further include hand mixing the solids with a hand mixer followed by power mixing the solids with a powered mixer to form the powder.

In aspects the method may further include adding water to the chamber by pouring water along sides of the chamber.

Another embodiment of the present disclosure is a geopolymer coating which includes fly ash and shrimp shell powder. The shrimp shell powder includes ground powder of shrimp shells with a particle size of about 850 μm. The geopolymer coating further includes sodium hydroxide (NaOH) and sodium silicate (Na₂SiO₃) at a ratio of 1:1.25, and water.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an example system that can be utilized to produce a geopolymer coating in accordance with the present disclosure; and

FIG. 2 illustrates a flow diagram for an example method for making a geopolymer formulation in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Geopolymer coatings formulated utilizing ground shrimp shell material in place of a portion of the fly ash may provide protection against chemical damage, fire damage, water damage, and damage due to high temperature. Such geopolymer coatings may reduce an amount of fly ash required and reduce landfilling.

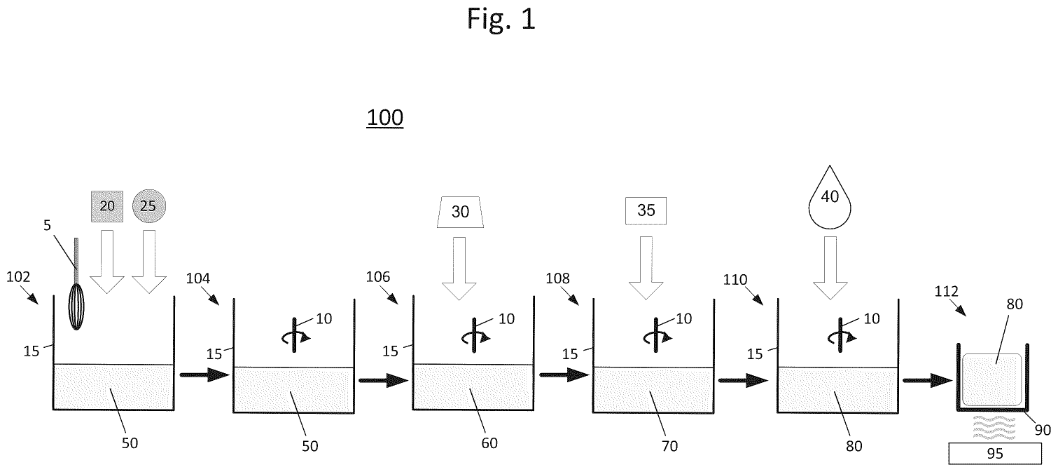

FIG. 1 shows a system 100 and method for making a geopolymer coating formulation arranged in accordance with at least some embodiments described herein. As discussed in more detail below, the geopolymer coating formulation produced using system 100 may provide an effective geopolymer coating for chemical, fire, water, and high temperature resistant applications as well as provide termite resistance and mold resistance.

System 100 may include a hand mixer 5, a powered mixer 10, a chamber 15, solids 20 and 25, alkalis 30 and 35, and water 40. Solids 20 may be a coal combustion product and may include particulates driven out of coal-fired boilers along with flue gases. Solids 20 may include construction grade fly ash including grades F and C fly ash, blast furnace slag, and/or metakaolin. Solids 20 may include oxides of silicon, aluminum iron, calcium, magnesium, potassium, sodium, titanium, and sulfur. Solids 20 may further include silicates, aluminosilicates, and calcium-alumina-silicates, solid sodium hydroxide, solid sodium silicate, solid potassium hydroxide, solid potassium silicate, mullite, anhydrous calcined form of the clay mineral kaolinite, and combinations thereof. Solids 25 may be biomass and may include shrimp shells. Solids 25 may be ground shrimp shells or a ground powder of shrimp shells, which may be retained on #20 mesh and may have crushed particles of about 850 μm in size. Solids 20 may be about 70 weight % to about 95 weight % of all solids and solids 25 may be about 5 weight % to about 30 weight % of all solids.

Alkali 30 and alkali 35 may be a substance with a pH value of more than 7 and may form a chemical salt when combined with an acid. Alkali 30 and alkali 35 may be alkali with a pH of approximately 10 to 13 such as, but not limited to sodium hydroxide (NaOH), sodium silicate (Na₂SiO₃), barium hydroxide (Ba(OH)₂), strontium hydroxide (Sr(OH)₂), potassium hydroxide (caustic potash) (KOH), calcium hydroxide (lime, CaO:H₂O) (Ca(OH)₂), trisodium phosphate (Na₃PO₄), potassium carbonate (K₂CO₃), sodium carbonate (soda ash) (Na₂CO₃), ammonium hydroxide (NH₃:H₂O)(NH₄OH), and magnesium hydroxide (MgO:H₂O)(Mg(OH)₂). Alkali 30 may be sodium hydroxide (NaOH) and alkali 35 may be sodium silicate (Na₂SiO₃). In some embodiments, alkali 30 may be 12.5M sodium hydroxide (NaOH) and alkali 35 may be 12.5M sodium silicate (Na₂SiO₃). Water 40 may be de-ionized water (DI H₂O).

A geopolymer coating 90 may be produced from a geopolymer coating formulation including solids 20 and 25, alkalis 30 and 35, and water 40. About 36 weight % of geopolymer coating 90 may be solids 20 and 25. About 4 weight % to about 5 weight % of geopolymer coating 90 may be alkalis 30 and 35. Alkalis 30 and alkali 35 may have a ratio of 1:1.25 within geopolymer coating 90. About 50 weight % to about 55 weight % of geopolymer coating 90 may be water 40. Amounts of solids 20 and 25, alkalis 30 and 35, and water 40 may be calculated based on a total quantity of geopolymer coating 90 to be produced and may be weighted out prior to production of geopolymer coating 90.

At 102, solids 20 and 25 may be placed into chamber 15. Solids 20 and 25 may be thoroughly mixed by hand with hand mixer 5 to form a powder 50. At 104, powder 50 of solids 20 and 25 may be mixed by powered mixer 10 for about 30 seconds. Powered mixer 10 may be any powered mixer known in the art. For example, powered mixer 10 may be a KUCCO electronic stand mixer and may be set to mix powder 50 at a power level 1 for about 30 seconds.

At 106, with powered mixer 10 running at a low setting, alkali 30 may be poured into chamber 15 and mixed with powder 50. Alkali 30 may be mixed with powder 50 by mixer 10 for about 5 minutes resulting in mixture 60. At 108, with powered mixer 10 running at a low setting, alkali 35 may be poured into chamber 15 and mixed with mixture 60. Alkali 35 may be mixed with mixture 60 by mixer 10 for about 1 minute resulting in mixture 70. At 110, with powered mixer 10 running at a low setting, water 40 may be added by pouring the water along sides of chamber 15 and mixed with mixture 70. Water 40 may be mixed with mixture 70 by mixer 10 for about 5 minute resulting in geopolymer coating 80.

For evaluation of geopolymer coating 80, at 112 geopolymer coating 80 may be poured into molds 90 and dried by an oven 95. Molds 90 may be 5.08×5.08 cm (2×2 in) cube molds which comply with ASTM C109 standards and molds 90 may be lined with vegetable oil prior to filling. The filled molds 90 may be placed into oven 95 and heated at about 70° C. for about 24 hours and then removed from oven 95 and allowed to air dry for about seven days to set prior to testing. The set cubes of dried geopolymer coating 80 were then used in flame, radiation, and porosity testing.

For the flame testing, the set cubes of dried geopolymer coating 80 were prepared with 5%, 10%, and 20% solids 25 (shrimp shell powder) and subjected to a flame from an acetylene-oxygen torch for a duration of about 30 seconds at about 0.5 meters, leading to an exposure of a temperature in the range of about 1600° C. to 2000° C. Control samples with 100% fly ash as solids 20 and no shrimp shell powder as solids 25 were also flame tested. The set of cubes of dried geopolymer coating 80 all displayed no structural deterioration after flame testing and only displayed some surface morphology change due to the flame test flame oxidizing the surface and increasing its hardness.

High temperature testing was performed by placing the set cubes of dried geopolymer coating 80 in a furnace at about 900° C. for about 1 hour. The set cubes of dried geopolymer coating 80 all displayed no structural deterioration, with only some surface morphology change similar to the results of the control samples after high temperature testing,

Porosity testing was performed by placing the set cubes of dried geopolymer coating 80 in water for about 24 hours. The set cubes of dried geopolymer coating 80 samples of 5% and 10% solids 25 (shrimp shell powder) held together structurally after the porosity testing.

Table 1 includes formulations for example geopolymer coatings 80 embodiments with solids 20 being fly ash, solids 25 being shrimp shell powder, alkali 30 being sodium hydroxide (NaOH), alkali 35 being sodium silicate (Na₂SiO₃), and water 40 being de-ionized water.

TABLE 1
Composition table for geopolymer coating preparation.

| Loading → | 5% Shrimp | 10% Shrimp | 20% Shrimp |
|---|---|---|---|
| Composition ↓ | Grams (g) | | |
| Fly Ash | 167.99 | 159.13 | 141.43 |
| Shrimp Powder | 8.86 | 17.69 | 35.40 |
| H₂O | 277.68 | 277.67 | 277.68 |
| NaOH | 18.97 | 18.97 | 18.98 |
| Na₂SiO₃ | 24.48 | 28.71 | 24.47 |
| Total Weight | 497.98 | 502.17 | 497.96 |

As shown in Table 1, in some embodiments, solid 20 may be fly ash and may comprise about 34 weight % of geopolymer coating 80, solid 25 may be shrimp shell powder and may comprise about 2 weight % of geopolymer coating 80, alkali 30 may be sodium hydroxide (NaOH) and may comprise about 4 weight % of geopolymer coating 80, alkali 35 may be sodium silicate (Na₂SiO₃) may comprise about 5 weight % of geopolymer coating 80, and water 40 being de-ionized water may comprise about 56 weight % of geopolymer coating 80. In some embodiments, solid 20 may be fly ash and may comprise about 32 weight % of geopolymer coating 80, solid 25 may be shrimp shell powder and may comprise about 3.5 weight % of geopolymer coating 80, alkali 30 may be sodium hydroxide (NaOH) and may comprise about 4 weight % of geopolymer coating 80, alkali 35 may be sodium silicate (Na₂SiO₃) may comprise about 5 weight % of geopolymer coating 80, and water 40 being de-ionized water may comprise about 56 weight % of geopolymer coating 80. In some embodiments, solid 20 may be fly ash and may comprise about 28 weight % of geopolymer coating 80, solid 25 may be shrimp shell powder and may comprise about 7 weight % of geopolymer coating 80, alkali 30 may be sodium hydroxide (NaOH) and may comprise about 4 weight % of geopolymer coating 80, alkali 35 may be sodium silicate (Na₂SiO₃) may comprise about 5 weight % of geopolymer coating 80, and water 40 being de-ionized water may comprise about 56 weight % of geopolymer coating 80.

The following tables include analysis data related to the composition of shrimp shells which may be utilized as solids 25 in geopolymer coating 80.

TABLE 2
mass % based on one spot spectra.

| | Mass Norm % | | | | Atom % | | | |
|---|---|---|---|---|---|---|---|---|
| | Raw | Raw | Shrimp | Shrimp | Raw | Raw | Shrimp | Shrimp |
| | Shrimp | Shrimp | HTC | HTC | Shrimp | Shrimp | HTC | HTC |
| Elements | spot A | spot B | 180 | 230 | spot A | spot B | 180 | 230 |
| Carbon | 45.57 | 48.8 | 11.59 | 46.5 | 54.16 | 56.32 | 51.35 | 56.01 |
| Nitrogen | 9.81 | 5.64 | 6.36 | 1.83 | 9.99 | 5.58 | 6.65 | 1.89 |
| Oxygen | 37.03 | 42.72 | 37.63 | 42.68 | 33.04 | 37.01 | 34.43 | 38.59 |
| Sodium | 0.05 | 0.19 | 0.02 | 0 | 0.03 | 0.11 | 0.01 | 0 |
| Magnesium | 0.22 | 0.07 | 0.43 | 0.28 | 0.13 | 0.04 | 0.26 | 0.17 |
| Phosphorus | 0.3 | 0.22 | 2.5 | 1.7 | 0.14 | 0.1 | 1.18 | 0.8 |
| Sulfur | 0.09 | 0.17 | 0.17 | 0.19 | 0.04 | 0.07 | 0.08 | 0.08 |
| Chlorine | 0 | 0.12 | 0 | 0.01 | 0 | 0.05 | 0 | 0 |
| Potassium | 0.01 | 0.08 | 0.06 | 0.05 | 0 | 0.03 | 0.02 | 0.02 |
| Calcium | 6.91 | 1.99 | 8.23 | 6.76 | 2.46 | 0.69 | 3.01 | 2.44 |
| N:P:K | 981 | 564 | 636 | 183 | 999 | 558 | 665 | 189 |
| | 30 | 22 | 250 | 170 | 14 | 10 | 118 | 80 |
| | 1 | 8 | 6 | 5 | 0 | 3 | 2 | 2 |

TABLE 2
mass % based on average sample spectra.

| | Mass Norm % | | | Atom % | | |
|---|---|---|---|---|---|---|
| | Raw | Shrimp HTC | Shrimp HTC | Raw | Shrimp HTC | Shrimp HTC |
| Elements | Shrimp | 180 | 230 | Shrimp | 180 | 230 |
| Carbon | 46.67 | 49.98 | 44.6 | 56.87 | 59.53 | 55.45 |
| Nitrogen | 6.04 | 2.58 | 2.02 | 6.32 | 2.64 | 2.15 |
| Oxygen | 35.02 | 38.43 | 39.43 | 32.03 | 34.36 | 36.8 |
| Sodium | 0.23 | 0 | 0.08 | 0.15 | 0 | 0.05 |
| Magnesium | 0.28 | 0.27 | 0.45 | 0.17 | 0.16 | 0.28 |
| Phosphorus | 1.39 | 1.77 | 2.21 | 0.66 | 0.82 | 1.06 |
| Sulfur | 0.28 | 0.14 | 0.22 | 0.13 | 0.06 | 0.1 |
| Chlorine | 0.14 | 0 | 0 | 0.06 | 0 | 0 |
| Potassium | 0.09 | 0.12 | 0.07 | 0.03 | 0.04 | 0.03 |
| Calcium | 9.85 | 6.7 | 10.91 | 3.6 | 2.39 | 4.07 |
| N:P:K | 604 | 258 | 202 | 632 | 264 | 215 |
| | 139 | 177 | 221 | 66 | 82 | 106 |
| | 9 | 12 | 7 | 3 | 4 | 3 |
| | | | | | 66 | |
| | | | | | 20.5 | |
| | | | | | 1 | |

A geopolymer coating in accordance with the present disclosure may provide heat resistance to a surface upon which it is applied. A geopolymer coating in accordance with the present disclosure may provide termite resistance to a surface upon which it is applied. A geopolymer coating in accordance with the present disclosure may provide mold resistance to a surface upon which it is applied. A geopolymer coating in accordance with the present disclosure may reduce fly ash requirements by replacing up to 30% of fly ash solids with shrimp shell powder.

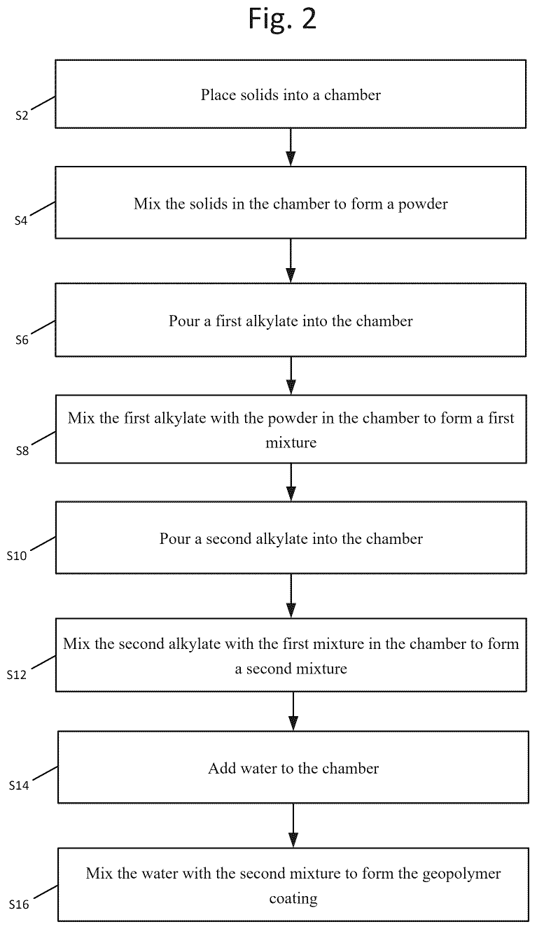

FIG. 2 illustrates a flow diagram for an example method for making a geopolymer coating in accordance with at least some aspects of the present disclosure. This example process may include one or more operations, actions, or functions as illustrated by one or more of blocks S2, S4, S6, S8, S10, S12, S14, and/or S16. Although illustrated as discrete blocks, various blocks may be divided into additional blocks, combined into fewer blocks, or eliminated, depending on the desired implementation.

The method may begin at block S2, “Place solids into a chamber.” At block S2, solids may be placed into a chamber. The solids may include construction grade fly ash and a ground powder of shrimp shells with a particle size of about 850 μm. The solids may include up to 30% shrimp shell powder.

The method may continue from block S2 to block S4, “Mix the solids in the chamber to form a powder.” At block S4, the solids may be mixed in the chamber to form a powder. The solids may be hand mixed with a hand mixer followed by power mixing the solids with a powered mixer to form the powder.

The method may continue from block S4 to block S6, “Pour a first alkali into the chamber.” At block S6, a first alkali may be poured into the chamber. The first alkali may be 12.5M sodium hydroxide (NaOH).

The method may continue from block S6 to block S8, “Mix the first alkali with the powder in the chamber to form a first mixture.” At block S8, the first alkali may be mixed with the powder in the chamber to form a first mixture. The mixing may be performed by a powered mixer at a low setting.

The method may continue from block S8 to block S10, “Pour a second alkali into the chamber.” At block S10, a second alkali may be poured into the chamber. The second alkali may be 12.5M sodium silicate (Na₂SiO₃).

The method may continue from block S10 to block S12, “Mix the second alkali with the first mixture in the chamber to form a second mixture.” At block S12, the second alkali may be mixed with the first mixture in the chamber to form a second mixture. The mixing may be performed by a powered mixer at a low setting.

The method may continue from block S12 to block S14, “Add water to the chamber.” At block S14, water may be added to the chamber. The water may be de-ionized water and may be poured along sides of the chamber.

The method may continue from block S14 to block S16, “Mix the water with the second mixture to form the geopolymer coating.” At block S16, the water may be mixed with the second mixture in the chamber to form the geopolymer coating. The mixing may be performed by a powered mixer at a low setting.

Finally, the processes and techniques described herein are not inherently related to any apparatus and may be implemented by any suitable combination of components. Further, various types of general-purpose devices may be used in accordance with the teachings described herein. It may also prove advantageous to construct specialized apparatus to perform the method steps described herein. This disclosure has been described in relation to the examples, which are intended in all respects to be illustrative rather than restrictive.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A geopolymer coating comprising:
solids including fly ash and shrimp shell powder;
a first alkali;
a second alkali; and
water,
wherein the geopolymer coating formulation provides heat resistance to an exposure of a temperature in the range of about 1600° C. to 2000° C.

2. The geopolymer coating of claim 1, wherein the solids include up to 30% shrimp shell powder.

3. The geopolymer coating of claim 1, wherein the first alkali is sodium hydroxide (NaOH).

4. The geopolymer coating of claim 3, wherein the second alkali is sodium silicate (Na₂SiO₃).

5. The geopolymer coating of claim 4, wherein the geopolymer coating has a ratio of first alkali to second alkali of 1:1.25.

6. The geopolymer coating of claim 1, wherein the shrimp shell powder includes ground powder of shrimp shells with a particle size of about 850 μm.

7. The geopolymer coating of claim 1, wherein the water is de-ionized water.

8. The geopolymer coating of claim 4, wherein:
the fly ash is about 34 weight %;
the shrimp shell powder is about 2 weight %;
the sodium hydroxide is about 4 weight %;
the sodium silicate is about 5 weight %; and
the water is about 56 weight % of the geopolymer coating.

9. The geopolymer coating of claim 4, wherein:
the fly ash is about 32 weight %;
the shrimp shell powder is about 3.5 weight %;
the sodium hydroxide is about 4 weight %;
the sodium silicate is about 5 weight %; and
the water is about 56 weight % of the geopolymer coating.

10. The geopolymer coating of claim 4, wherein:
the fly ash is about 28 weight %;
the shrimp shell powder is about 7 weight %;
the sodium hydroxide is about 4 weight %;
the sodium silicate is about 5 weight %; and
the water is about 56 weight % of the geopolymer coating.

11. A method of producing as geopolymer coating, the method comprising:
placing solids into a chamber;
mixing the solids in the chamber to form a powder;
pouring a first alkali into the chamber;
mixing the first alkali with the powder in the chamber to form a first mixture;
pouring a second alkali into the chamber;
mixing the second alkali with the first mixture in the chamber to form a second mixture;
adding water to the chamber; and
mixing the water with the second mixture to form the geopolymer coating.

12. The method of claim 11, wherein mixing the solids in the chamber to form a powder comprises:
hand mixing the solids with a hand mixer followed by power mixing the solids with a powered mixer to form the powder.

13. The method of claim 11, wherein placing the solids into the chamber solids includes placing fly ash and up to 30% shrimp shell powder into the chamber.

14. The method of claim 13, wherein the shrimp shell powder includes ground powder of shrimp shells with a particle size of about 850 μm.

15. The method of claim 11, wherein pouring the first alkali into the chamber includes pouring sodium hydroxide into the chamber.

16. The method of claim 15, wherein pouring the second alkali into the chamber includes pouring sodium silicate into the chamber.

17. The method of claim 16, wherein the geopolymer coating has a ratio of first alkali to second alkali of 1:1.25.

18. The method of claim 11, wherein adding water to the chamber includes pouring water along sides of the chamber.

19. The method of claim 18, wherein the water is de-ionized water.

20. A geopolymer coating comprising:
fly ash;
shrimp shell powder, wherein the shrimp shell powder includes ground powder of shrimp shells with a particle size of about 850 μm;
12.5M sodium hydroxide and 12.5M sodium silicate at a ratio of 1:1.25; and
water.
